(19) United States
(12) Patent Application Publication
(10) Pub. No.: US 2022/0051861 A1
(43) Pub. Date: Feb. 17, 2022

(54) Rotational Push Switch

(71) Applicant: Joemex Electric Products (Dongguan) Co., Ltd, Dong Guan City (CN)

(72) Inventor: Albert Huang, Taipei (TW)

(21) Appl. No.: 16/991,496

(22) Filed: Aug. 12, 2020

(51) Int. Cl. H01H 19/36; H01H 19/14; H01H 19/04

(52) U.S. Cl. CPC H01H 19/36; H01H 19/14; H01H 2235/00; H01H 2221/01; H01H 19/04

(57) ABSTRACT

A rotational push switch includes a bottom shell having a first and a second conductive terminals connected to a power supply, and a third conductive terminal connected to the conductive elastic piece. The conductive elastic piece is mounted in the bottom shell. A switch assembly is mounted on a top shell mounted on the bottom shell. The switch assembly is switched to connect or detach the conductive elastic piece and the second conductive terminal. A cap is mounted on the switch assembly. When the conductive elastic piece is connected to or departed from the second conductive terminal, ON/OFF symbols can be correspondingly seen in a display window of the cap, and a user can recognize an ON/OFF state of the rotational push switch.

### BACKGROUND OF THE INVENTION

### 1. Field of the Invention

The present invention relates to a switch, and more particularly to a rotational push switch for controlling transmission of electric power or signals.

### 2. Description of the Related Art

Push switches are widely used in various fields. For example, the push switches are usually used in electronic products, tools, vehicles, or industrial equipment, and the push switches can control a transmission circuit of an electric power or a signal. The push switch can be alternately switched between an ON state and an OFF state by pressing a switch portion of the push switch. However, it is difficult to recognize ON/OFF states of the push switches according to outward appearances of the push switches. Although heights of the switch portions of the push switches will be changed according to whether the push switches have been pressed or not, the heights of the switch portions are changed quite slightly, which is difficult for the user to visually recognize the ON/OFF states of the push switches. Therefore, it is still quite inconvenient for the user in terms of practical applications.

### SUMMARY OF THE INVENTION

An objective of the present invention is to provide a rotational push switch whose ON/OFF state can he easily recognized.

The rotational push switch includes a bottom shell, a conductive elastic piece, a top shell, a switch assembly, and a cap.

The bottom shell includes a first conductive terminal, a second conductive terminal, and a third conductive terminal which are mounted inside the bottom shell. One end of the first conductive terminal and one end of the second conductive terminal respectively extend outward from a front side of the bottom shell. One end of the third conductive terminal extends outward from a back side of the bottom shell.

One end of the conductive elastic piece is mounted inside the bottom shell, and is electrically connected to the third conductive terminal. Another end of the conductive elastic piece elastically contacts the second conductive terminal.

The top shell correspondingly engages with the bottom shell, and includes an annular seat mounted on a top of the top shell.

The switch assembly is mounted in the annular seat of the top shell to press the conductive elastic piece to make the conductive elastic piece and the second conductive terminal electrically connected or electrically isolated. The switch assembly includes a rotatable push unit, and the push unit includes a plurality of alternately arranged ON symbols and OFF symbols which are mounted on a top of the push unit.

The cap is slidably mounted on the top shell to correspondingly press the switch assembly to make the switch assembly press the conductive elastic piece. The cap includes a display window mounted on a top of the cap. When the conductive elastic piece is electrically connected to the second conductive terminal, the display window aligns with one of the ON symbols of the push unit. When the conductive elastic piece is electrically isolated from the second conductive terminal, the display window aligns with one of the OFF symbols of the push unit.

A user can alternately switch the rotational push switch to the ON state or the OFF state by repeatedly pressing the cap. When the rotational push switch is switched to the ON/OFF state, the ON/OFF symbols can be correspondingly rotated to align with the display window by the switch assembly. The user can see the ON/OFF symbols through the display window to quickly recognize the ON/OFF state of the rotational push switch.

Other objectives, advantages, and novel features of the invention will become more apparent from the following detailed description when taken in conjunction with the accompanying drawings.

### BRIEF DESCRIPTION OF THE DRAWINGS

FIG. 1 is a front view of a rotational push switch of the present invention;

FIG. 2 is an exploded view of the rotational push switch of the present invention;

FIG. 3 is a back view of the rotational push switch of the present invention;

FIG. 4 a sectional view of a top shell of the rotational push switch of the present invention;

FIG. 5 is an exploded view of the top shell, a driving cylinder, and a rotational cylinder of the rotational push switch of the present invention;

FIG. 6A is a sectional view of the rotational push switch in an ON state;

FIG. 6B is an upward sectional view of a cutting line A-A of FIG. 6A;

FIG. 6C is a plan view of the driving cylinder and the rotational cylinder when the rotational push switch is in the ON state;

FIG. 7A is a sectional view of the rotational push switch in an OFF state;

FIG. 7B is an upward sectional view of a cutting line B-B of FIG. 7A;

FIG. 7C is a plan view of the driving cylinder and the rotational cylinder when the rotational push switch is in the OFF state;

FIG. 8 is a top view of the rotational push switch of the present invention;

FIG. 9 is a schematic view of the rotational push switch having different conductive terminals;

FIG. 10 is a schematic view of a circuit connection of the rotational push switch in an actual application.

### DETAILED DESCRIPTION OF THE INVENTION

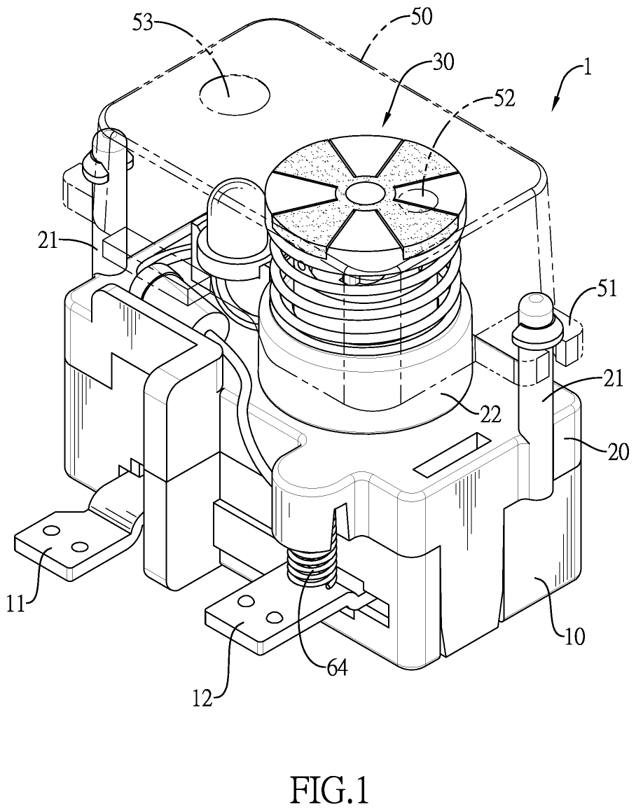

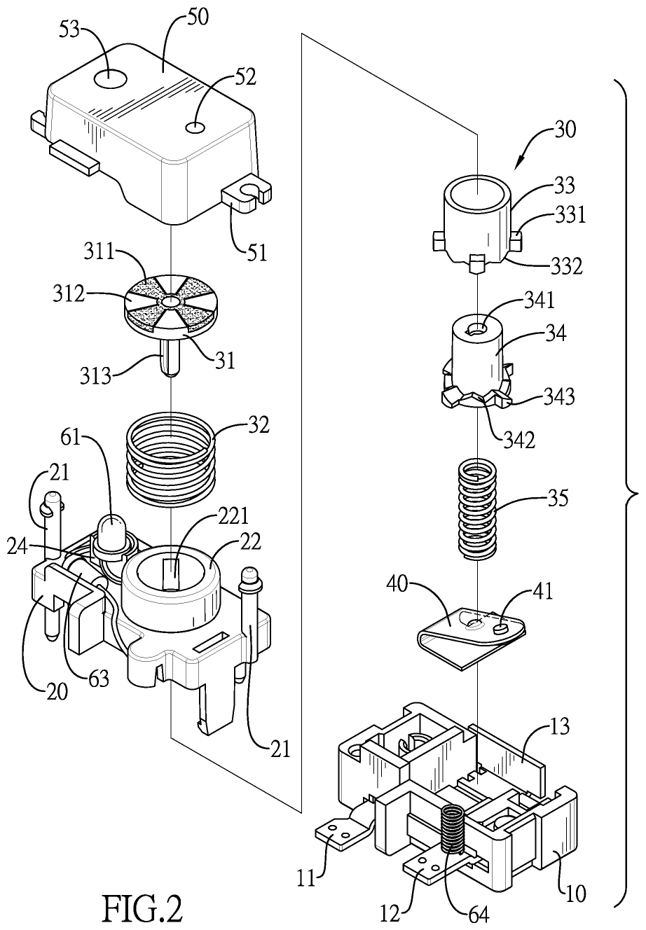

With reference to FIG. 1 and FIG. 2, the present invention is a rotational push switch 1, and the rotational push switch 1 includes a bottom shell 10, a top shell 20, a switch assembly 30, a conductive elastic piece 40, and a cap 50.

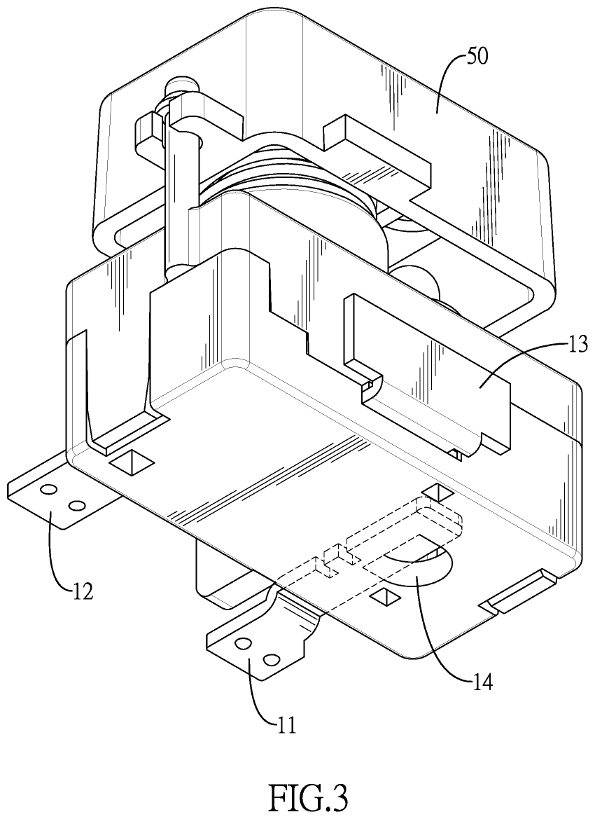

The bottom shell 10 and the top shell 20 are engaged to form a complete shell. The bottom shell 10 includes a first conductive terminal 11, a second conductive terminal 12, and a third conductive terminal 13. One end of the first conductive terminal 11 is mounted inside the bottom shell 10, and another end of the first conductive terminal 11 extends outward from a front side of the bottom shell 10. One end of the second conductive terminal 12 is mounted inside the bottom shell 10, and another end of the second conductive terminal 12 extends outward from the front side of the bottom shell 10. The end of the second conductive terminal 12 inside the bottom shell 10 forms a lower contact 121. With reference to FIG. 3, the third conductive terminal 13 is an L-shaped conductive piece. One end of the third conductive terminal 13 is mounted inside the bottom shell 10, and another end of the third conductive terminal 13 extends outward from a back side of the bottom shell 10, and is bent upward. A bottom of the bottom shell 10 forms a through hole 14, and the first conductive terminal 11 is correspondingly exposed out of the through hole 14. The first conductive terminal 11 can be electrically connect to a load device via the through hole 14.

The conductive elastic piece 40 is mounted inside the bottom shell 10. One end of the conductive elastic piece 40 is mounted inside the bottom shell 10 and electrically connects to the third conductive terminal 13, and another end of the conductive elastic piece 40 forms an upper contact 41. The upper contact 41 can elastically contact the lower contact 121 of the second conductive terminal 12.

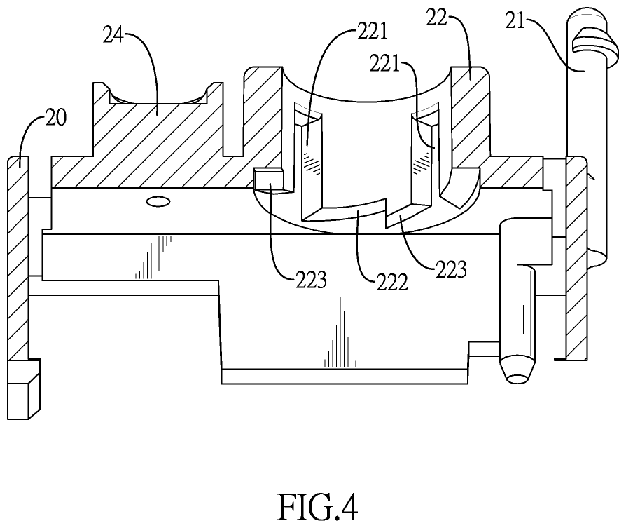

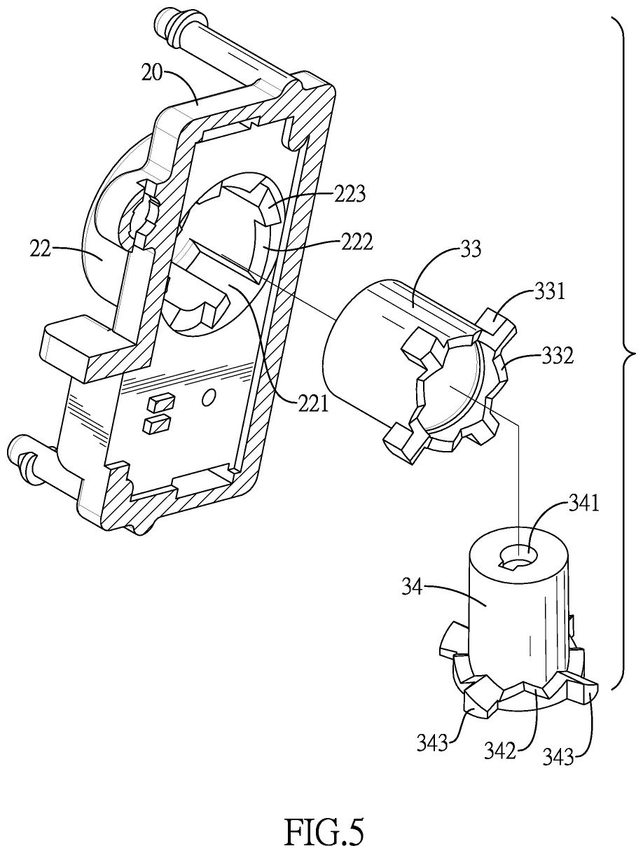

The top shell 20 engages with the bottom shell 10 on a top of the bottom shell 10. Two guide posts 21 are respectively formed by extending upward from two opposite sides of the top shell 20. The guide posts 21 can be mounted at diagonally opposite corners of the top shell 20. An annular seat 22 is formed by extending upward from a top of the top shell 20. An opening is formed through the bottom of the annular seat 22. Via the opening of the bottom of the annular seat 22, an inner space of the annular seat 22 communicates with an inner space of the complete shell which is formed by engaging the bottom shell 10 and the top shell 20. With reference to FIG. 4 and FIG. 5, an inner wall of the annular seat 22 is recessed to form a plurality of guide grooves 221, and the guide grooves 221 respectively extend along an axial direction of the annular seat 22. A plurality of oblique slots 222 and a plurality of oblique blocks 223 are alternately formed on a periphery of the opening of the bottom of the annular seat 22. The oblique slots 222 and the oblique blocks 223 are inclined along a same direction. In an embodiment, an indicator light seat 24 is formed on the top of the top shell 20, and the indicator light seat 24 is positioned adjacent to the annular seat 22.

The switch assembly 30 is mounted on the annular seat 22 to push the conductive elastic piece 40 to an ON position or an OFF position. The switch assembly 30 includes a push unit 31, a return spring 32, a driving cylinder 33, a rotational cylinder 34, and a push spring 35.

The push unit 31 includes an indicator portion and a rod. The indicator portion includes a plurality of ON symbols 311 and a plurality of OFF symbols 312. The ON symbols 311 and the OFF symbols :312 are alternately arranged on a top of the indicator portion of the push unit 31 to display the ON state or the OFF state of the rotational push switch 1. In the embodiment, the indicator portion is circular, and includes four ON symbols 311 and four OFF symbols 312. The ON symbols 311 and the OFF symbols 312 are fan-shaped sectors, and colors of the ON symbols 311 are different from colors of the OFF symbols 312. An angle between centerlines of two adjacent sectors is 45 degrees. The rod extends downward from the bottom of the indicator portion. A protrusive rib 313 is formed on an outer wall of the rod and extends along an axial direction of the rod.

A bottom of the return spring 32 is mounted on a top of the annular seat 22. A top of the return spring 32 supports the indicator portion of the push unit 31. When the push unit 31 is pressed, the return spring 32 provides a resilient force to the push unit 31.

The driving cylinder 33 is movably mounted inside the annular seat 22. A plurality of protrusive blocks 331 are formed on an outer wall of the driving cylinder 33, and a plurality of sharp toothed portions 332 are formed on a bottom of the driving cylinder 33. A number of the protrusive blocks 331 is same as a number of the guide grooves 221 of the annular seat 22, and the protrusive blocks 331 respectively engage with the guide grooves 221 to limit that the driving cylinder 33 can only move up and down in the annular seat 22. Namely, the driving cylinder 33 cannot rotate relative to the annular seat 22.

The rotational cylinder 34 is mounted inside the driving cylinder 33. A key hole 341 is formed on a top of the rotational cylinder 34. The rod of the push unit 31 is mounted through the driving cylinder 33 and the key hole 341 of the rotational cylinder 34, and the protrusive rib 313 correspondingly engages with the key hole 341. When the rotational cylinder 34 rotates, the push unit 31 can rotate with the rotational cylinder 34. A plurality of oblique toothed portions 342 and a plurality of blocks 343 are alternately and continuously formed around an outer wall of a bottom of the rotational cylinder 34. The blocks 343 respectively extend outward along a radial direction of the rotational cylinder 34. The oblique toothed portions 342 and the blocks 343 each have a respective oblique surface formed on a top thereof.

The push spring 35 is mounted inside the rotational cylinder 34. One end of the push spring 35 contacts an inner wall of a top side of the rotational cylinder 34, and another end of the push spring 35 contacts the conductive elastic piece 40. When the push spring 35 is pressed, the push spring 35 pushes the conductive elastic piece 40 to make the upper contact 41 of the conductive elastic piece 40 correspondingly contact the lower contact 121 of the second conductive terminal 12. When the push spring 35 is not pressed, the upper contact 41 of the conductive elastic piece 40 can be detached from the lower contact 121 of the second conductive terminal 12.

The cap 50 is slidably mounted on the guide posts 21 of the top shell 20, and covers the top shell 20 and the switch assembly 30 to facilitate a user to press the cap 50 for switching between the ON/OFF states of the rotational push switch 1. After the cap 50 is pressed, the push unit 31 can push the cap 50 to an original position of the cap 50 by the resilient force of the return spring 32. In the embodiment, two engagement portions 51 are respectively formed on two opposite sides of the cap 50, and the engagement portions 51 respectively engage with the guide posts 21 of the top shell 20. A display window 52 is formed on a top of the cap 50. The display window 52 can be a through hole, or is made of a transparent unit, such as glass or acrylic. A position of the display window 52 corresponds to a position of the push unit 31 to expose out one of the ON symbols 311 or one of the OFF symbols 312. A light-transmissive portion 53 is further formed on the top of the cap 50, and a position of the light-transmissive portion 53 corresponds to the indicator light seat 24 of the top shell 20.

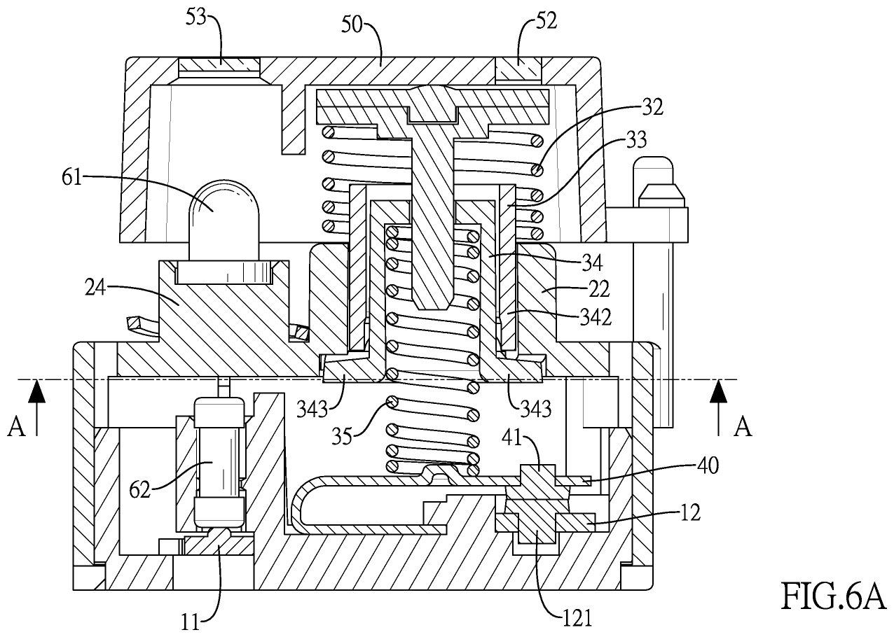

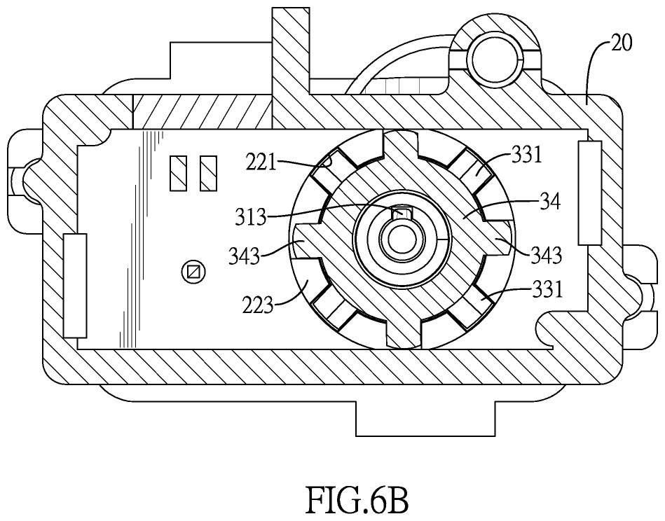

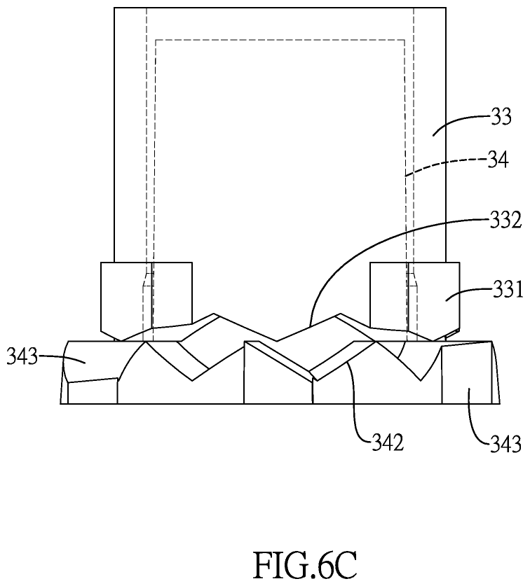

The rotational push switch 1 further includes an indicator light assembly 60. The indicator light assembly 60 includes a light emitting diode (LED) 61, a resistor 62, a diode 63, and a conductive spring 64. Further with reference to FIG. 6A, the LED 61 is mounted in the indicator light seat 24 of the top shell 20. One conductive pin of the LED 61 is electrically connected to the resistor 62, and further to the first conductive terminal 11 through the resistor 62. The resistor 62 is mounted inside the bottom shell 10. Another conductive pin of the LED 61 is electrically connected to one end of the diode 63, and another end of the diode 63 is electrically connected to the second conductive terminal 12 through the conductive spring 64. Since the LED 61 is electrically connected between the first conductive terminal 11 and the second conductive terminal 12, when the first conductive terminal 11 and the second conductive terminal 12 electrically connect to a power supply, the LED 61 can emit light without being influenced by the ON/OFF state of the rotational push switch 1.

With reference to FIG. 6A to FIG. 6C, when the rotational push switch 1 is in the ON state, the block 343 mounted on the bottom of the rotational cylinder 34 contacts the oblique block 223 of the annular seat 22 to make the push spring 35 inside the rotational cylinder 34 pressed. When the push spring 35 is pressed, the push spring 35 further pushes the conductive elastic piece 40 to the ON position to make the upper contact 41 of the conductive elastic piece 40 contact the lower contact 121.

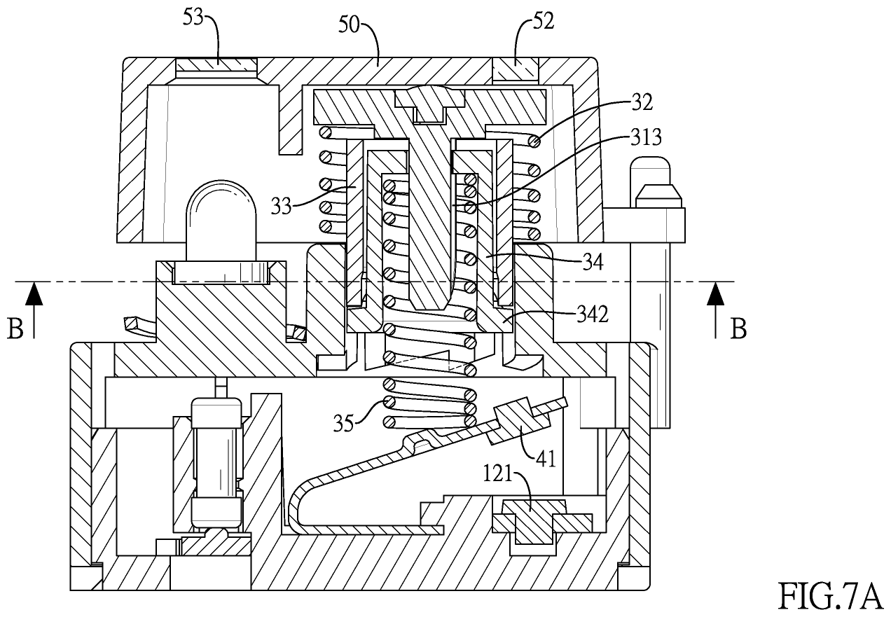

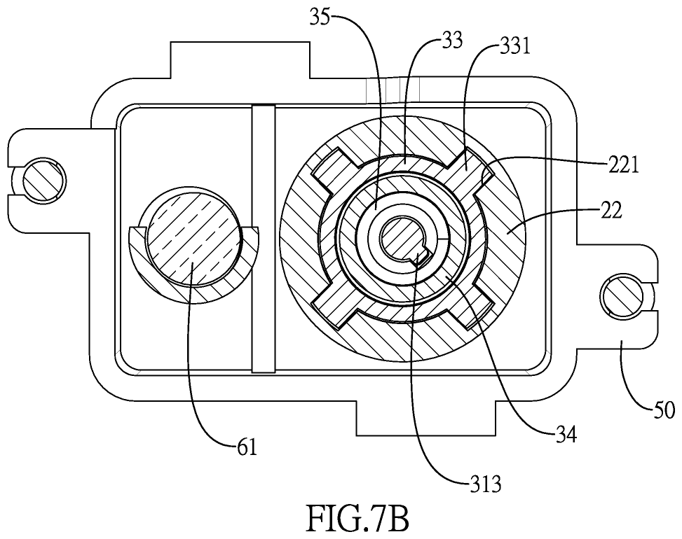

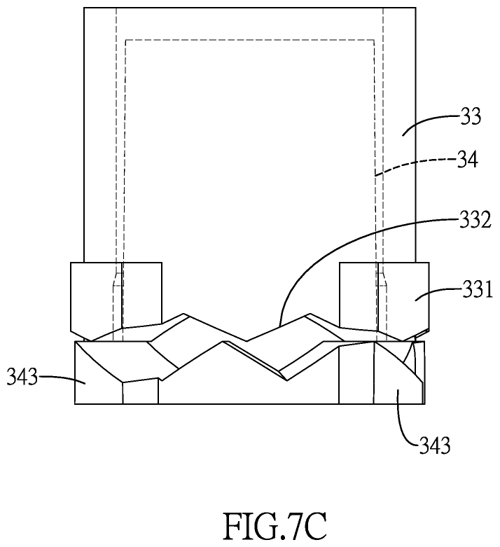

When the rotational push switch 1 is in the ON state as shown in FIG. 6A, the user can press the cap 50 to switch the rotational push switch 1 to the OFF state as shown in FIG. 7A to FIG. 7C. When the cap 50 is pressed, the push unit 31 can be pushed downward by the cap 50, and the push unit 31 can further push the driving cylinder 33 and the rotational cylinder 34. The block 343 mounted on the bottom of the rotational cylinder 34 is pushed to detach from the oblique block 223 of the annular seat 22, and the sharp toothed portions 332 mounted on the bottom of the driving cylinder 33 simultaneously pushes the oblique toothed portion 342 of the rotational cylinder 34. Since the oblique toothed portion 342 has the oblique surface, when the oblique toothed portion 342 is pushed, the rotational cylinder 34 rotates. As shown in FIG. 7C, when the block 343 of the rotational cylinder 34 is rotated to be aligned with the guide groove 221, the block 343 of the rotational cylinder 34 is approximately aligned with the protrusive block 331 of the driving cylinder 33, and slides into the guide groove 221 with the protrusive block 331 of the driving cylinder 33. Then, the rotational cylinder 34 is pushed by the push spring 35 to be raised up, and the push spring 35 returns to an original state from a pressed state. Since the conductive elastic piece 40 is not pushed by the push spring 35, the upper contact 41 is detached from the lower contact 121 such that the conductive elastic piece 40 is in the OFF position. Namely, the rotational push switch 1 is in the OFF state.

When the user presses the cap 50 again, the rotational push switch 1 is switched from the OFF state to the ON state, as shown in FIG. 6A to FIG. 6C. When the cap 50 is pressed, the driving cylinder 33 is pressed downward to push the oblique toothed portion 342 of the rotational cylinder 34 to make the rotational cylinder 34 rotate. As shown in FIG. 6C, when the block 343 of the rotational cylinder 34 rotates along the oblique slot 222 to contact the oblique block 223, the block 343 of the rotational cylinder 34 and the protrusive block 331 of the driving cylinder 33 are substantially staggered. The push spring 35 inside the rotational cylinder 34 is pressed to push the conductive elastic piece 40 to make the upper contact 41 of the conductive elastic piece 40 contact the lower contact 121.

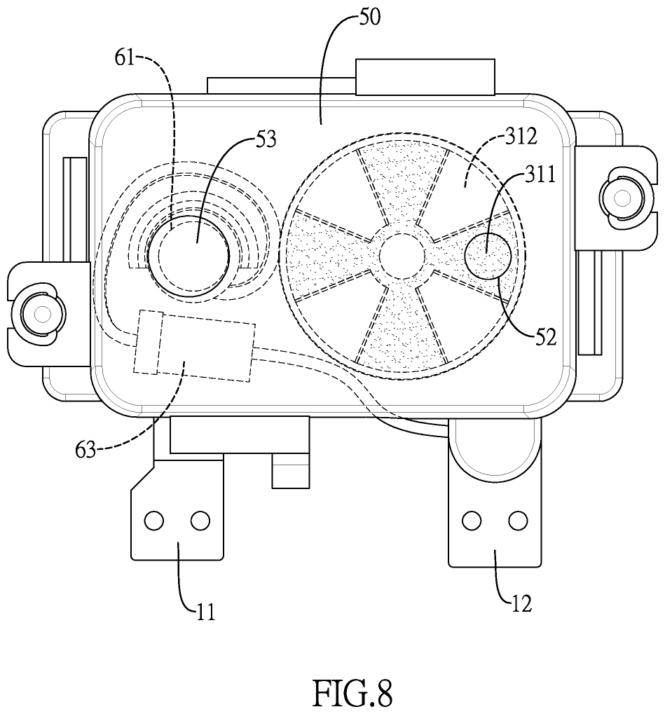

With reference to FIG. 8, each time when the cap 50 is pressed to drive the rotational cylinder 34 to rotate, the rotational cylinder 34 further drives the push unit 31 to rotate together to make the ON symbols 311 and the OFF symbol 312 sequentially rotate to a position corresponding to the display window 52. When the rotational push switch 1 is in the ON state, the ON symbol 311 of the push unit 31 corresponds to the display window 52. When the rotational push switch 1 is in the OFF state, the OFF symbol 312 of the push unit 31 corresponds to the display window 52. Therefore, the user can conveniently recognize the ON/OFF state of the rotational push switch 1 through the display window 52.

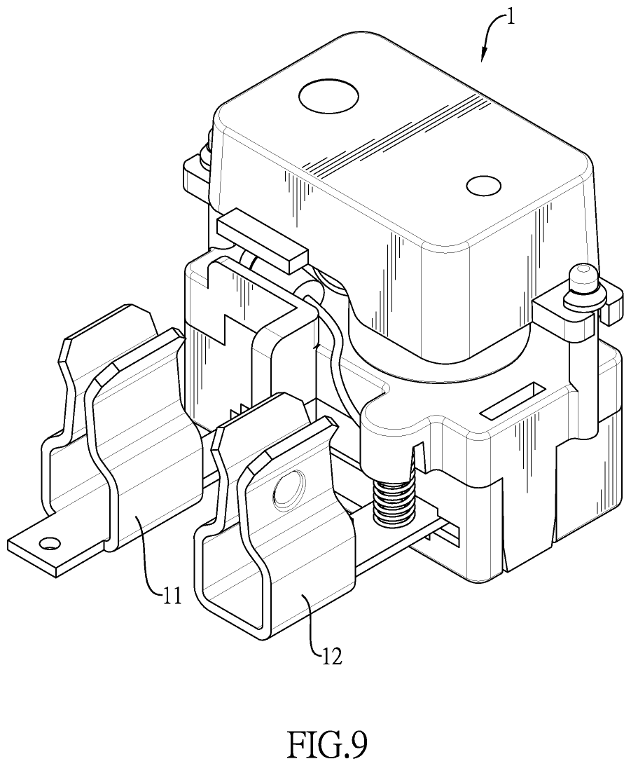

With reference to FIG. 9, structures of the first conductive terminal 11, the second conductive terminal 12, and the third conductive terminal 13 can be modified according to requirements. For example, in the embodiment as shown in FIG. 9, the first conductive terminal 11 and the second conductive terminal 12 each include a respective clamping portion. The clamping portions of the first conductive terminal 11 and the second conductive terminal 12 can clamp power contacts of the power supply to electrically connect to the power supply.

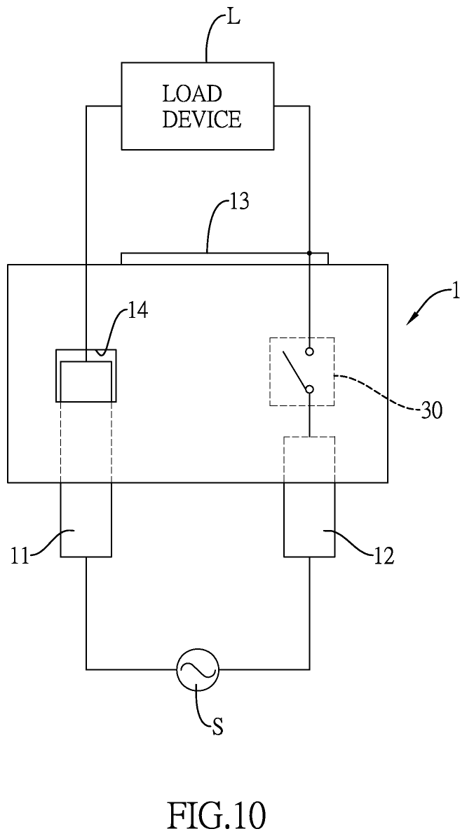

With reference to FIG. 10, a schematic view shows a circuit connection of the rotational push switch 1 in an actual application. The first conductive terminal 11 and the second conductive terminal 12 are respectively electrically connected to two terminals of the power supply S. One terminal of a load device L is electrically connected to the first conductive terminal 11 through the through hole 14 of the bottom shell 10, and another terminal of the load device L is electrically connected to the third conductive terminal 13. Since the switch assembly 30 can control whether the third conductive terminal 13 is electrically connected to the second conductive terminal 12 or not, when the rotational push switch 1 is in the ON state, the load device L can be electrically connected to the power supply S through the rotational push switch 1 to receive electric power.

In summary, the use can press the cap 50 to switch the ON/OFF state of the rotational push switch 1. Further, the user can conveniently recognize the ON/OFF state of the rotational push switch 1 according to the ON/OFF symbols 311, 312 in the display window 52 of the cap 50.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A rotational push switch, comprising:
a bottom shell, comprising a first conductive terminal, a second conductive terminal, and a third conductive terminal mounted inside the bottom shell;
wherein one end of the first conductive terminal and one end of the second conductive terminal respectively extend outward from a front side of the bottom shell; wherein one end of the third conductive terminal extends outward from a back side of the bottom shell;
a conductive elastic piece; wherein one end of the conductive elastic piece is mounted inside the bottom shell, and is electrically connected to the third conductive terminal; Wherein another end of the conductive elastic piece elastically contacts the second conductive terminal;
a top shell, correspondingly engaging with the bottom shell; wherein the top shell comprises an annular seat mounted on a top of the top shell;
a switch assembly, mounted in the annular seat of the top shell to press the conductive elastic piece to make the conductive elastic piece and the second conductive terminal electrically connected or electrically isolated; wherein the switch assembly comprises a rotatable push unit, and the push unit comprises a plurality of alternately arranged ON symbols and OFF symbols mounted on a top of the push unit;
a cap, slidably mounted on the top shell to correspondingly press the switch assembly to make the switch assembly press the conductive elastic piece;
wherein the cap comprises a display window mounted on a top of the cap;
wherein when the conductive elastic piece is electrically connected to the second conductive terminal, the display window aligns with one of the ON symbols of the push unit; wherein when the conductive elastic piece is electrically isolated from the second conductive terminal, the display window aligns with one of the OFF symbols of the push unit.

2. The rotational push switch as claimed in claim 1, wherein an inner wall of the annular seat is recessed to form a plurality of guide grooves, and the guide grooves respectively extend along an axial direction of the annular seat; wherein the annular seat comprises a plurality of oblique slots and a plurality of oblique blocks, and the oblique slots and the oblique blocks are alternately formed on a periphery of an opening of a bottom of the annular seat; wherein the oblique slots and the oblique blocks are inclined along a same direction;
wherein the switch assembly comprises:
the push unit, comprising an indicator portion and a rod; wherein the indicator portion comprises said ON symbols and said OFF symbols alternately arranged on a top of the indicator portion of the push unit; wherein the rod extends downward from a bottom of the indicator portion, and the rod comprises a protrusive rib formed on an outer wall of the rod; wherein the protrusive rib extends along an axial direction of the rod;
a return spring, mounted between a top of the annular seat and the bottom of the indicator portion;
a driving cylinder, movably mounted inside the annular seat; wherein the driving cylinder comprises a plurality of protrusive blocks formed on an outer wall of the driving cylinder, and a plurality of sharp toothed portions formed on a bottom of the driving cylinder;
a rotational cylinder, mounted inside the driving cylinder; wherein the rotational cylinder comprises a key hole formed on a top of the rotational cylinder;
wherein the rod of the push unit is mounted through the driving cylinder and the key hole of the rotational cylinder, and the protrusive rib correspondingly engages in the key hole; wherein the rotational cylinder further comprises a plurality of oblique toothed portions and a plurality of blocks, and the oblique toothed portions and the blocks are alternately and continuously formed around an outer wall of a bottom of the rotational cylinder; wherein the oblique toothed portions and the blocks are pushed by the sharp toothed portions of the driving cylinder to rotate;
a push spring, mounted between an inner wall of a top side of the driving cylinder and the conductive elastic piece;
wherein when the rotational cylinder is rotated to make the block contact the oblique block, the push spring pushes the conductive elastic piece to make the conductive elastic piece electrically connected to the second conductive terminal; wherein when the rotational cylinder is rotated to make the block slide into the guide groove, the conductive elastic piece is detached from the second conductive terminal.

3. The rotational push switch as claimed in claim 2, wherein the top shell further comprises:
an indicator light seat, positioned adjacent to the annular seat;
a light emitting diode (LED), mounted in the indicator light seat;
a resistor, mounted inside the bottom shell, and electrically connected between the first conductive terminal and one end of the LED;
a diode, electrically connected between the second conductive terminal and another end of the LED;
wherein the cap comprises a light-transmissive portion formed on the top of the cap, and a position of the light-transmissive portion is corresponding to a position of the LED.

4. The rotational push switch as claimed in claim 1, wherein the ON symbols and the OFF symbols are fan-shaped sectors, and colors of the ON symbols are different from colors of the OFF symbols.

5. The rotational push switch as claimed in claim 2, wherein the ON symbols and the OFF symbols are fan-shaped sectors, and colors of the ON symbols are different from colors of the OFF symbols.

6. The rotational push switch as claimed in claim 3, wherein the ON symbols and the OFF symbols are fan-shaped sectors, and colors of the ON symbols are different from colors of the OFF symbols.

7. The rotational push switch as claimed in claim 4, wherein an angle between centerlines of two adjacent said sectors is 45 degrees.

8. The rotational push switch as claimed in claim 5, wherein an angle between centerlines of two adjacent said sectors is 45 degrees.

9. The rotational push switch as claimed in claim 6, wherein an angle between centerlines of two adjacent said sectors is 45 degrees.

10. The rotational push switch as claimed in claim 7, wherein the top shell further comprises two guide posts, and the two guide posts are respectively formed by extending upward from two opposite sides of the top shell;
wherein the cap comprises two engagement portions, and the two engagement portions are respectively formed on two opposite sides of the cap to respectively engage with the two guide posts of the top shell.

11. The rotational push switch as claimed in claim 8, wherein the top shell further comprises two guide posts, and the two guide posts are respectively formed by extending upward from two opposite sides of the top shell;
wherein the cap comprises two engagement portions, and the two engagement portions are respectively formed on two opposite sides of the cap to respectively engage with the two guide posts of the top shell.

12. The rotational push switch as claimed in claim 9, wherein the top shell further comprises two guide posts, and the two guide posts are respectively formed by extending upward from two opposite sides of the top shell;
wherein the cap comprises two engagement portions, and the two engagement portions are respectively formed on two opposite sides of the cap to respectively engage with the two guide posts of the top shell.

13. The rotational push switch as claimed in claim 10, wherein the third conductive terminal is an L-shaped conductive piece; wherein one end of the third conductive terminal is mounted inside the bottom shell, and another end of the third conductive terminal extends outward from the back side of the bottom shell, and is bent upward.

14. The rotational push switch as claimed in claim 11, wherein the third conductive terminal is an L-shaped conductive piece; wherein one end of the third conductive terminal is mounted inside the bottom shell, and another end of the third conductive terminal extends outward from the back side of the bottom shell, and is bent upward.

15. The rotational push switch as claimed in claim 12, wherein the third conductive terminal is an L-shaped conductive piece; wherein one end of the third conductive terminal is mounted inside the bottom shell, and another end of the third conductive terminal extends outward from the back side of the bottom shell, and bent upward.

16. The rotational push switch as claimed in claim 13, wherein the display window of the cap is a transparent unit.

17. The rotational push switch as claimed in claim 14, wherein the display window of the cap is a transparent unit.

18. The rotational push switch as claimed in claim 15, wherein the display window of the cap is a transparent unit.
